(19) United States
(12) Patent Application Publication
(10) Pub. No.: US 2016/0237233 A1
(43) Pub. Date: Aug. 18, 2016

(54) STYRENE-CARBOXYLIC ACID COPOLYMER FOAM

(71) Applicant: DOW GLOBAL TECHNOLOGIES LLC, Midland, MI (US)

(72) Inventors: Lawrence S. Hood, Midland, MI (US); Stéphane Costeux, Midland, MI (US); Scott T. Matteucci, Midland, MI (US)

(73) Assignees: Dow Global Technologies LLC, Midland, MI (US); Dow Global Technologies LLC, Midland, MI (US)

(21) Appl. No.: 15/023,742

(22) PCT Filed: Oct. 29, 2014
(86) PCT No.: PCT/US2014/062816

§ 371 Date: Mar. 22, 2016

Related U.S. Application Data
(60) Provisional application No. 61/902,458, filed on Nov. 11, 2013.

(51) Int. Cl. C08J 9/14; F16L 59/02

(52) U.S. Cl. CPC C08J 9/146; F16L 59/028; C08J 2325/08

(57) ABSTRACT

Prepare a polymer foam by expanding a foamable polymer composition of a copolymer component and a blowing agent where the copolymer component accounts for more than 50 weight-percent of the total polymer weight in the foamable polymer composition and is one or more than one styrene-carboxylic acid copolymer having an acid number of 20 or higher while the blowing agent comprises a fluorinated blowing agent, less than 70 weight-percent of which is 1,1,2,2-tetrafluoroethane and less than five weight-percent is carbon dioxide and C3-C5 hydrocarbons make up less than 30 mole-percent of the blowing agent; expand the foamable polymer composition into a polymer foam having an average cell size of less than 0.5 millimeters where the copolymer composition is a continuous phase in the polymer foam.

### BACKGROUND OF THE INVENTION

### Field of the Invention

The present invention relates to a process for preparing polymeric foam comprising a styrene-carboxylic acid copolymer continuous phase.

### INTRODUCTION

Thermally insulating polymer foam often contains fluorinated blowing agents. Fluorinated blowing agents are desirable because they tend to have a low thermal conductivity. A challenge with thermally insulating foam containing fluorinated blowing agents is that when the fluorinated blowing agent diffuses out of the foam the thermal conductivity of the foam tends to increase. That means that the foam becomes less thermally insulating over time. Another related challenge associated fluorinated blowing agents is that fluorinated blowing agent can be detrimental to global warming. Therefore, it is desirable to minimize the diffusion of fluorinated blowing agents from polymer foam in order to minimize the increase in thermal conductivity through the foam over time and reduce release of fluorinated blowing agents into the environment.

U.S. Pat. No. 5,439,947 addresses the problem of blowing agent diffusion in polymeric foam by incorporating a hydrogen bonding blocking agent into the polymer matrix of the foam and using a hydrogen-containing halocarbon blowing agent. The blowing agent tends to hydrogen bond with the blocking agent thereby inhibiting diffusion of the blowing agent through the foam. Suitable blocking agents have ether, ester or ketone groups. It is desirable to avoid having to include additional additives into a polymer foam formulation in order to inhibit blowing agent diffusion through the foam.

U.S. Pat. No. 6,063,823 addresses a similar problem by blending 0.1 to 30 weight-parts of a polymer containing oxygen, nitrogen, fluorine or 0.1 to 10 weight-parts of an oxy acid or its derivative with 100 weight-parts polystyrene in order to improve the low solubility of hydrofluorocarbon blowing agents in the polystyrene.

Both U.S. Pat. No. 5,439,947 and U.S. Pat. No. 6,063,823 require blending a component with polystyrene and then preparing polymeric foam from that blend. It is desirable to be able to prepare styrenic polymer foam that has a lower diffusivity with respect to fluorinated blowing agents than polystyrene but that does not require blending hydrogen bonding additives with the styrenic polymer or using a blend of a polymer with polystyrene to form the styrenic polymer foam.

### BRIEF SUMMARY OF THE INVENTION

The present invention solves the problem of reducing diffusivity of a fluorinated blowing agent from styrenic polymer foam, relative to polystyrene foam, without requiring a blocking agent additive or a blend of polystyrene and another polymer in the styrenic polymer foam or the process of preparing the styrenic foam. Moreover, the present invention solves this problem while further achieving styrenic polymer foam with cell sizes of less than 0.5 millimeters, which is ideal for thermally insulating foam. The present invention surprisingly forms a styrenic polymer foam having reduced fluorinated blowing agent diffusivity through the polymer of the foam without having to use a blend of polystyrene and another additive or a polymer blend.

Surprisingly, the present invention is a result of discovering that foam having the desirably characteristics to solve the aforementioned problems is achievable by using a polymer composition that is more than 50 weight-percent based on total polymer weight of styrene-carboxylic acid copolymer where the acid number of the copolymer is 20 or higher. Notably, as illustrated in the Examples section herein, copolymers having an acid number lower than 20 are insufficient to result in decreased diffusivity of fluorinated blowing agents. Rather, the copolymer must possess both the carboxylic acid functionalities and have an acid number of 20 or higher to reduce fluorinated blowing agent diffusivity. The process of the present invention can comprise a single styrenic polymer in an absence of hydrogen bonding blocking agents and yet achieve reduced diffusivity of fluorinated blowing agents relative to polystyrene.

In a first aspect, the present invention is a process for preparing polymer foam, the process comprising expanding a foamable polymer composition into a polymer foam wherein the foamable polymer composition comprises a copolymer component and a blowing agent, the process further characterized by: (a) the copolymer component consisting of one or more than one styrene-carboxylic acid copolymer; (b) more than 50 weight-percent of the total polymer weight in the foamable polymer composition being copolymer component; (c) the acid number of the copolymer component being 20 or higher; (d) the blowing agent comprising at least one fluorinated blowing agent and less than 70 weight-percent of the total fluorinated blowing agent is 1,1,2,2-tetrafluoroethane; (e) the blowing agent comprising less than five weight-percent carbon dioxide based on total blowing agent weight and less than 30 mole-percent hydrocarbons having from three to five carbons based on total moles of blowing agent; and (f) the foamable polymer composition expanding into a polymer foam having an average cell size of less than 0.5 millimeters as determined by ASTM D3576 and wherein the copolymer composition forms a continuous phase in the resulting polymer foam.

The process of the present invention is useful for preparing polymer foam that is useful, for example, as a thermally insulating material.

### DETAILED DESCRIPTION OF THE INVENTION

Test methods refer to the most recent test method as of the priority date of this document unless a date is indicated with the test method number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

“Polymer” includes polymers consisting of all of the same monomers copolymerized together (homopolymers) as well as polymers comprising combinations of two or more than two different monomers copolymerized together (copolymers).

“Copolymer” refers to a polymer of two or more different monomers or monomer-containing polymers that have been grafted together, copolymerized together, or contain a portion that have been grafted and a portion that have been copolymerized. Unless otherwise indicated, “copolymer” includes block copolymer, graft copolymer, alternating copolymer and random copolymer.

“And/or” means “and, or as an alternative”. All ranges include endpoints unless otherwise indicated.

The process of the present invention is a process for preparing polymer foam. In general, the process includes providing a foamable polymer composition that comprises a copolymer component and a blowing agent and then expanding that foamable polymer composition into polymer foam where the copolymer component forms a continuous phase in the resulting polymer foam. The process, in its broadest scope, can be any process for producing polymer foam. For example, the process can be a batch foam process, an extrusion foam process. Likewise, the process can be a molded process where foamable polymer composition expands within a mold or a process where the foamable polymer composition expands without the constraints of being within a mold.

One example of a batch process includes providing the foamable polymer composition in a plasticized state and under sufficient pressure so as to preclude foaming and then releasing the pressure to allow the foamable polymer composition to expand.

Expanded bead foaming is another form of batch foam process where beads of foamable polymer composition are placed within a mold and heated to soften the polymer component of the bead thereby allowing the blowing agent to expand the beads to fill the mold. The beads typically fuse together either by use of an adhesive on the beads or by intermingling of the polymers of adjoining beads fusing the beads together.

The process can be an extrusion process where a foamable polymer composition is extruded from an environment of higher pressure through a die into an atmosphere at a lower pressure that allows the foamable polymer composition to expand into polymer foam. Extrusion foam processes can be continuous or batch. Continuous extrusion processes continuously extrude foamable polymer composition through a die and that continuous extrudate expands into a continuous polymer foam extrudate that can be cut into pieces (for example, sheets, boards, billets, tubes, or even pellets). Desirably, the extrusion process allows the extruded foamable polymer to expand into polymer foam in an environment free of the constraints of a mold.

The copolymer component consists of one or more than one styrene-carboxylic acid copolymer. A styrene-carboxylic acid copolymer is a copolymer of styrene and one or more than one carboxylic acid monomer. Examples of suitable carboxylic acid monomers include acrylic acid, methacrylic acid, 4-vinyl benzoic acid, maleic acid and fumaric acid.

The copolymer component has an acid number of 20 or higher, preferably 40 or higher, still more preferably 60 or higher, yet more preferably 70 or higher and can be 80 or higher, 90 or higher, 100 or higher, 120 or higher, 140 or higher, 160 or higher, 180 or higher, even 200 or higher. At the same time, the acid number for the copolymer component desirably has an acid number of 250 or less. Acid number is a measure of how many acid functionalities are present in the copolymer composition. In particular, acid number is the total milligrams of potassium hydroxide needed to neutralize (achieve pH 7) the free fatty acids present in one gram of substance (copolymer component). Determine acid number for a polymer according to the method set forth in the Examples section, below.

More than 50 weight-percent (wt %), preferably 75 wt % or more, still more preferably 90 wt % or more and possibly 90 wt % or more and even 99 wt % or more or 100 wt % of the total polymer weight in the foamable polymer composition and continuous phase of the resulting polymer foam is the copolymer component. At the same time, the copolymer component is generally amorphous.

Notably, the foamable polymer composition can be free of styrenic polymers other than the copolymer component.

The blowing agent comprises or even consists of one or more than one fluorinated blowing agent. Fluorinated blowing agents are desirable because they tend to lower the thermal conductivity through a polymer foam. Many fluorinated blowing agents are also relatively harmless to the environment. Suitable fluorinated blowing agents for use in the blowing agent of the present invention include fluorinated materials containing from 2 to 5 carbon atoms, preferably that are free of chlorine. Some examples of suitable fluorinated blowing agents include perfluoromethane, ethyl fluoride (HFC-161), 1,1,-difluoroethane (HFC-152a), 1,1,1-trifluoroethane (HFC-143a), 1,1,2,2-tetrafluoroethane (HFC-134), 1,1,1,2 tetrafluoroethane (HFC-134a), pentafluoroethane (HFC-125), perfluoroethane, 2,2-difluoropropane (HFC-272fb), 1,1,1-trifluoropropane (HFC-263fb), 1,1,1,2,3,3,3-heptafluoropropane (HFC-227ea), 1,1,1,3,3-pentafluoropropane (HFC-245fa), 1,1,1,3,3-pentafluorobutane (HFC-365mfc) and 1,3,3,3-tetrafluoropropene (HFO-1234ze), 3-fluoropropene (HFO-1261zf), and 1,1,1-trifluoropropoene (HFO-1243zf). Particularly desirable fluorinated blowing agents are selected from HFC-152a, HFC-134a and HFO-1234ze. As long as the blowing agent has at least one fluorinated blowing agent, the blowing agent can be free of any one or any combination of more than one of the aforementioned fluorinated blowing agents.

While the blowing agent comprises fluorinated blowing agent, the blowing agent comprises less than 70 weight-percent (wt %), preferably 50 wt % or less, more preferably 30 wt % or less, still more preferably 20 wt % or less, yet more preferably 10 wt % or less and can be free of 1,1,2,2-tetrafluoroethane (HFC-134).

In addition to the one or more than one fluorinated blowing agent, the blowing agent can comprise additional blowing agents such as one or any combination of more than one selected from water, aliphatic and cyclic hydrocarbons having from one to nine carbons including methane, ethane, propane, n-butane, isobutane, n-pentane, isopentane, neopentane, cyclobutane, and cyclopentane; aliphatic alcohols having from one to five carbons such as methanol, ethanol, n-propanol, and isopropanol; carbonyl containing compounds such as acetone, 2-butanone, and acetaldehyde; ether containing compounds such as dimethyl ether, diethyl ether, methyl ethyl ether; carboxylate compounds such as methyl formate, methyl acetate, ethyl acetate; and chemical blowing agents such as azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-dinitrosoterephthalamide, trihydrazino triazine and sodium bicarbonate. The blowing agent can be free of any one or any combination of more than one of the aforementioned blowing agents.

However, the blowing agent comprises less than five wt % and can contain four wt % or less, three wt % or less, two wt % or less, one wt % or less or even be free of carbon dioxide.

The blowing agent can also comprise less than 30 mole-percent, even 25 mol % or less saturated hydrocarbons containing from three to five carbons based on total moles of blowing agent. The blowing agent can comprise less than 5 mol-percent water and carbon dioxide (individually or as a combination) based on total moles of blowing agent.

Desirably, the total amount of blowing agent present is two wt % or more, preferably three wt % or more, more preferably four wt % or more and at the same time desirably 15 wt % or less, preferably 12 wt % or less and more preferably 10 wt % or less based on total weight of polymer in the foamable polymer composition.

The foamable polymer composition can comprise additional components in addition to the copolymer composition and the blowing agent. Examples of suitable additional components include colorants, antioxidants, flame retardants, nucleators, lubricants, stabilizers, and infrared attenuating agents. Typically, the foamable polymer composition contains less than five wt % additional components based on total foamable polymer composition weight. Desirably, the foamable polymer composition and resulting polymer foam is essentially free or even completely free of propylene carbonate, ethylene carbonate and butylene carbonate

The conditions of the process of the present invention are selected so that the foamable polymer composition expands into a polymer foam having an average cell size of less than 0.5 millimeters and which can be 0.3 millimeter or less, 0.25 millimeters or less, 0.10 millimeter or less even 0.05 millimeters or less. Typically, conditions are such that the resulting foam has an average cell size of one micrometer or more. Determine average cell size according to ASTM D3576

At the same time, it is desirable to select a foamable polymer composition and process conditions that produce a polymer foam having an open cell content of 30 percent or less, preferably 20 percent or less, still more preferably 10 percent or less, yet more preferably 5 percent or less and yet more preferably one percent or less as measured according to ASTM D6226.

The resulting polymer foam has a continuous copolymer composition phase. For avoidance of any doubt, if water is present in the resulting foam the concentration of copolymer composition exceeds that of water.

### Examples

### Determination of Acid Number

Determine acid number for a polymer using the following titration method and reagents. The reagents are:
Isopropyl alcohol (IPA) (obtained from Fisher, Atlanta, Ga.)
Toluene (obtained from Fisher, Atlanta, Ga.)
Tetrabutylammonium Hydroxide (TBAOH) (1 Molar in methanol, obtained from Fisher, Atlanta, Ga.).
Titration Solvent (solution of 5 milliliters (mL) water, 495 mL IPA and 500 mL toluene)
Titrant is 0.1 molar TBAOH in IPA
Potassium hydrogen phthalate (KHP) (certified A.C.S. grade obtained from Fisher, Atlanta, Ga.)
Milli-Q water, or equivalent for use as “water”

Prepare samples by adding 0.1 to 0.99 grams of polymer sample into a 120 mL wide-mouth disposable glass bottle and record weight using a 3-place balance. Then, add approximately 65 mL of titration solvent. Stir vigorously on a stir plate using a polytetrafluoroethylene magnetic stirring bar until all polymer is dissolved.

Determine the concentration of the titrant by titrating the titrant with the 0.1 Molar KHP in Milli-Q water (2.04 grams KHP per 100 mL Milli-Q water). Titrate each sample using the titrant with constant stirring of the sample throughout titration. Record the final end point at the inflection point of the titration curve. Analyze a blank consisting of 65 mL Titration Solvent.

Calculate the acid number for the polymer in the sample in terms of milligrams potassium hydroxide per gram of polymer (KOH mg/g) using the following equation:

KOH mg/g=[(56.1)(A−B)M]/W

where: A is the volume of titrant (in mL) used to titrate the sample to its end point; B is the volume of titrant (in mL) to titrate the blank to its end point; M is the concentration of titrant in moles per liter and W is the mass of polymer in the sample.

For titrations, use a Metrohm 904 Titrando general purpose potentiometric titrator with a saturated lithium chloride in ethanol Solvotrode and a 10 mL burette.

Polymers for Use in Examples

Table 1 identifies the polymers used in the following evaluations and examples.

TABLE 1

| | | | Acid Number |
|---|---|---|---|
| Name | Polymer | Description | (mg KOH/g) |
| PS | Polystyrene | 280 kg/mol average Mw*, glass | 0\hat{ } |
| | homopolymer | transition temperature (Tg) of 100° C., | |
| | | density of 1.047 g/mL. Sigma-Aldrich | |
| | | product number 182427. | |
| PS168 | Polystyrene | 168 kg/mol average Mw*. 2.3 | 0\hat{ } |
| | homopolymer | Mw/Mn**. Glass transition | |
| | | temperature of 100° C. | |
| HDPE | High density | 0.80 dg/10 min Melt Index; 0.961 | 0\hat{ } |
| | polyethylene | g/cm³ density; DSC Melting Point | |
| | | 133° C.; UNIVAL ™ DMDH-6400 NT | |
| | | 7 HDPE (UNIVAL is a trademark of | |
| | | The Dow Chemical Company | |
| PP | Polypropylene | 3 dg/min (2.16 kg, 230° C.) Melt flow | 0\hat{ } |
| | homopolymer | Index; INSPIRE ™ D 404.01 resin | |
| | | (INSPIRE is a trademark of Braskem | |
| | | America, Inc.). | |
| SAA-1 | Styrene-acrylic | 2 wt % acrylic acid; average Mw* of | 15 |
| | acid copolymer | 204 kilograms/mole (kg/mol); | |
| | | Mw/Mn** of 2.45. | |
| SAA-2 | Styrene-acrylic | 8 wt % acrylic acid; average Mw* of | 64 |
| | acid copolymer | 152 kilograms/mole (kg/mol); | |
| | | Mw/Mn** of 2.34. | |
| SAA 690 | Styrene-acrylic | Approximately 35 wt % acrylic acid; | 228 |
| | acid copolymer | 16.5 kg/mol average Mw; glass | |
| | | transition temperature of 105. | |
| | | Available as SAA Joncryl ™ 690 resin. | |
| | | Joncryl is a trademark of BASF | |
| | | Corporation. | |
| SAA | Styrene-acrylic | Approximately 33 wt % acrylic acid]; | 217 |
| HPD-671 | acid copolymer | 17 kg/mol average Mw; glass | |
| | | transition temperature of 120. | |
| | | Available as SAA Joncryl ™ HPD-671 | |
| | | resin. | |
| SMAA-1 | Styrene-methacrylic | 2 wt % methacrylic acid; average Mw* | 16 |
| | acid copolymer | of 401 kg/mol; Mw/Mn** of 3.21. | |
| SMAA-2 | Styrene-methacrylic | 9 wt % methacrylic acid; average Mw* | 57 |
| | acid copolymer | of 178; Mw/Mn** of 2.4. | |
| SMaH | Styrene-maleic | 14 wt % maleic anhydride; Mw* of 195 | 71 |
| | anhydride copolymer | kg/mol, Mw/Mn** of 2.1. Dylark 332. | |
| SMMA | Styrene-methyl | 100-150 kg/mol average Mw; 40 mole- | 0 |
| | methacrylate | percent styrene; 101° C. glass transition | |
| | copolymer | temperature onset. Sigma Aldrich | |
| | | product number 462896. | |

*Mw is weight average molecular weight as determined by gel permeation chromatography.
**Mw/Mn is the polydispersity, which is the ratio of weight average molecular weight divided by number average molecular weight (Mn). Determine Mw and Mn by gel permeation chromatography.
Molecular weight values in this table and as reported in this document are apparent molecular weight values as measured by gel permeation chromatography (GPC), relative to a polystyrene standard. GPC molecular weight determinations are done using an Agilent 1100 series liquid chromatograph equipped with two Polymer Laboratories PLgel 5 micrometer Mixed-C columns connected in series and an Agilent G1362A refractive index detector, with tetrahydrofuran (THF) flowing at a rate of one milliliter per minute and heated to a temperature of 35° C. as the eluent.
\hat{ }Acid number was not measured for PS, PS168, HDPE or PP but since there are no acid functionalities or functionalities that form acid functionalities in these polymers an acid number of 0 is reasonably projected.

Synthesis for SAA and SMAA

Prepare SAA-1, SAA-2, SMAA-1 and SMAA-2 by emulsion polymerization using the following procedure and changing the type and amount of the carboxylic acid monomer to produce the desired copolymer. The procedure below is for SMAA-1. Precharge a reaction vessel with deionized water and BASF DISPONIL™ FES 32 surfactant (4 wt % relative to DI water weight) and heat to 87° C. while continuously stirring.

Prepare a monomer emulsion consisting of 28 wt % deionized water, 0.2 wt % sodium styrene sulfonate, 0.6 wt % DISPONIL FES 32 surfactant, 1.4 wt % methacrylic acid and 69.8 wt % styrene. Add N-dodecyl mercaptan at a loading necessary to produce the desired molecular weight distribution. Inject a blend of iron (II) sulfate hepahydrate in deionized water (0.15 wt % solution with 6 drops of sulfuric acid added per 500 milliliters (mL) of solution), ethylenediaminetetraacetic acid (EDTA) tetrasodium salt (one wt % in deionized water) at a ratio of 13 weight-parts iron (II) sulfate solution to 9 weight-parts EDTA salt solution. The mass of the iron (II) sulfate and EDTA solution to mass of styrene feed is three wt %. Inject ammonium persulfate and deionized water to form the monomer emulsion. The ratio of ammonium persulfate to deionized water is 2.7 weight-parts to 10 weight-parts. The mass of this blend per mass of styrene is 1.7 wt %.

Dropwise add the monomer emulsion into the reaction vessel over three hours. Add ammonium persulfate in deionized water (1.1 weight-parts per 30 weight-parts respectively) and sodium bisulfate in deionized water (1.2 weight-parts per 30 weight-parts respectively) with the monomer emulsion. The feed rate for the ammonium persulfate solution and the sodium bisulfite solutions are 4.2 percent of the feed rate of the styrene by mass. Upon reaching the desired mass of polymer, cool the kettle to 80° C. and terminate the polymerization by first adding iron (II) sulfate solution as described above (0.4 wt % by weight of initial styrene mass) and the adding t-butyl hydroperoxide in deionized water (0.4 weight-parts per 10 weight-parts respectively) at a loading of 1.4 wt % per initial mass of styrene and then add sodium formaldehyde sulfoxylate in deionized water (0.32 weight-parts per 10 weight-parts respectively). The mass of this solution is 1.4 wt % per initial mass of styrene. Cool the reactor to approximately 23° C. During cooling, and upon reaching 65° C., add two solutions concurrently over 20 minutes: Solution #1: 1.8 weight parts of t-butyl hydroperoxide per 100 weight-parts water; and Solution #2: 0.9 weight-parts sodium formaldehyde sulfoxylate per 10 weight-parts water. Injection masses are 1.6 and 1.5 wt % of each solution respectively per initial mass of styrene. Dry the resulting latex at approximately 23° C. for several days and then overnight at 60° C. in a vacuum oven.

Diffusivity Evaluation

Diffusion coefficient measurements are used to evaluate diffusivity of fluorinated blowing agents with respect to particular polymer resin compositions. Measure a diffusion coefficient for a polymer by making films of the polymer. Make films by first pressing pellets or powder of a polymer at 180 degrees Celsius (° C.) into a film having a thickness of approximately 1.27 millimeters (50 mils). Let the film cool. Then press the film a second time at 200° C. to produce a film having a thickness between 200 and 500 microns. Measure the steady state flux of gas at 35° C. through the film as described in U.S. Pat. No. 8,343,257. For a film having a thickness L, determine the lag time θ, which is the intercept of the time axis by the extrapolation of the linear region of a plot of the steady state flux versus time. Calculate the diffusion coefficient, D, using the equation:

D=L²/(6θ)

For reference purposes, measure the diffusion coefficients for polystyrene (PS), high density polyethylene (HDPE) and polypropylene (PP) using a variety of fluorinated blowing agents. Notably, PS, HDPE and PP all have an acid number of zero.

Results for the reference materials are in Table 2. These results reveal that the crystalline material (HDPE and PP) have a lower diffusivity than the amorphous material (PS). Due to their very narrow temperature processing window, crystalline polymers are difficult to foam, much more difficult than amorphous polymers so they are not a desirable solution to the problem solved by the present invention.

The blowing agents herein are 1,1,1,2-tetrafluoroethane (R-134a, HFC-134a), 1,1-difluoroethane (R-152a) and 1,3,3,3-tetrafluoropropene (HFO-1234ze)

TABLE 2

| | | | D | |
|---|---|---|---|---|
| | Blowing | D | (normalized | Amorphous (A) or |
| Polymer | agent | (cm²/s) | to PS) | Crystalline (C)? |
| PS | R-134a | 1.42E−08 | 1 | A |
| PS | R-152a | 1.67E−08 | 1 | A |
| PS | HFO-1234ze | 3.69E−08 | 1 | A |
| HDPE | R-134a | 1.14E−08 | 0.8 | C |
| HDPE | R-152a | 7.85E−09 | 0.47 | C |
| HDPE | HFO-1234ze | 2.56E−08 | 0.69 | C |
| PP | R-134a | 2.70E−09 | 0.19 | C |

Determine diffusion coefficients for the amorphous copolymers as well. Results are in Table 3. Results show that only the copolymers with carboxylic acid functionality and an acid number of 20 or higher have a lower diffusion coefficient for fluorinated blowing agents relative to PS. Notably, SMaH does not have a carboxylic acid functionality. The acid number value for SMaH is a result of hydrolysis of the anhydride to yield a diacid during the test method for measuring acid number.

TABLE 3

| | | | | D |
|---|---|---|---|---|
| | Acid Number | Blowing | D | (normalized |
| Polymer | (mg KOH/g) | agent | (cm²/s) | to PS) |
| SMaH | 71 | R-134a | 3.72E−8 | 2.62 |
| SMMA | 0 | R-134a | 3.78E−08 | 2.66 |
| SMAA-1 | 16 | R-152a | 4.02E−08 | 2.41 |
| SMAA-2 | 57 | R-152a | 1.89E−09 | 0.11 |
| SAA-1 | 15 | R-152a | >2E−08 | >1 |
| SAA-2 | 64 | R-152a | 9.51E−09 | 0.57 |
| SAA-2 | 64 | R-134a | 7.68E−10 | 0.05 |
| SAA-2 | 64 | HFO-1234ze | 1.58E−08 | 0.43 |

Batch Foaming Examples

Compression mold the polymer component into plaques having typical dimensions of 50 millimeters (mm) by 50 mm by 1.5 millimeter at 180° C. under 8.6 megaPascals pressure for two minutes. Cut the resulting plaque into pieces approximately 15 mm by 5 mm in size for use in the foaming process.

Carry out the foaming in a high pressure stainless steel cylindrical vessel (225 mm deep and 75 mm internal diameter) such as that available from HiP. Position the vessel in a temperature controlled chamber and connect the vessel to a blowing agent source via an Isco syringe pump (model 260D) and a depressurization device comprising an air actuated ball valve. Fill the approximately less that 5% of the vessel volume with the pieces of compression molded plaque polymer components. Seal the vessel and pressurize with the blowing agent to a Soak Pressure while at a Soak Temperature for a specific period of time (Soak Time), as stated with the samples below. After soaking with the blowing agent for the specific Soak Time, release the pressure in the vessel by opening the air actuated ball valve. Inside, the polymer compound expands to form a polymeric foam article. The Samples are further annealed after being retrieved from the pressure vessel in a silicon oil bath at 100° C. for 3 minutes to complete foaming.

Characterize average cell size final polymeric foam article by the method below. Cut a thin foam slice with a fresh razor blade generate an image of the foam section either by optical microscopy or scanning electron microscopy. Trace 2 parallel lines on the foam image that intersect different cells. Measure the larger dimension of every cell intersected each of the lines. Average the measured dimensions to obtain the average cell size. Results are in Table 4.

TABLE 4

| | | | | Soak | Soak | | Foam |
|---|---|---|---|---|---|---|---|
| | | Acid | | pres- | temper- | Soak | average |
| Exam- | | num- | Blowing | sure | ature | time | cell size |
| ple | Polymer | ber | agent | MPa | ° C. | (hrs) | (μm) |
| EX1 | SAA-2 | 64 | R-134a | 10.3 | 125 | 96 | 7.2 |
| EX2 | SMAA-2 | 57 | R-134a | 10.3 | 125 | 96 | 11.8 |

The process for preparing EX 1 and EX 2 illustrate processes of the present invention. The polymers of EX1 and EX2 have been shown above to have lower diffusivity with respect to fluorinated blowing agents than polystyrene and this process illustrates how to prepare polymer foam from those polymers in a batch process.

Extrusion Foaming Examples

Produce extruded foam articles using a small-scale foam line consisting of a 25 mm diameter extruder screw, mixing and cooling unit operations, and a ⅛″ adjustable die. Use 5 lbs/hr solids feed rate. For SAA 690 and PS 168 foams, melt resins with dry additives [0.3 phr DOWLEX™ 2247 g LLDPE, 0.2 phr talc, 0.1 phr barium stearate, 0.74 phr Saytex™ HP-900 hexabromocyclododecane (Saytex is a trademark of Albemarle Corp.), 0.11 phr Huntsman Chemical Araldite® ECN1280 ortho-cresol novolac epoxy resin (Araldite is a trademark of Huntsman International LLC), and 0.11 phr Irganox™ B215 stabilizer (Irganox is a trademark of BASF)], introduce blowing agents (4 phr HFC-134a and 0.33 phr water) at 170-190° C. and mix to form a foamable composition, cool foamable composition to 135-155° C. depending on the Tg of the resin. Note: no dry additives are included in the SAA HPD 691 foam.

Process parameter for Ex 3 are: 13.4 MPa extruder pressure, 7.4 MPa die outlet pressure, 130° C. die setpoint, 4.0 millimeter (mm) die gap and relatively slow foam take-away speed.

Process parameter for Ex 4 are: 14.1 MPa extruder pressure, 7.9 MPa die outlet pressure, 155° C. die setpoint, 4.7 millimeter (mm) die gap and relatively slow foam take-away speed.

Process parameter for Comp Ex A are: 22.8 MPa extruder pressure, 6.8 MPa die outlet pressure, 135° C. die setpoint, 2.5 millimeter (mm) die gap and relatively fast foam take-away speed.

Process parameter for Comp Ex B are: 22.7 MPa extruder pressure, 7.7 MPa die outlet pressure, 138° C. die setpoint, 1.7 millimeter (mm) die gap and relatively slow foam take-away speed.

Measure foam density according to ASTM D1622, open cell content according to ASTM D6226, average cell size according to ASTM D3576. Results are in Table 5.

TABLE 5

| | | | Cross | | Open | Foam |
|---|---|---|---|---|---|---|
| | | | sectional | | cell | average |
| Exam- | | Acid | area | Density | content | cell size |
| ple | Polymer | number | (cm²) | (kg/m³) | (%) | (μm) |
| EX3 | SAA 690 | 228 | 6.6 | 75.3 | 8 | 130 |
| EX4 | SAA HPD- | 217 | 6.6 | 76.6 | 13 | 270 |
| | 671 | | | | | |
| Comp | PS168 | 0 | 1.7 | 78.7 | 0 | 250 |
| Ex A | | | | | | |
| Comp | PS168 | 0 | 3.7 | 65.8 | 37 | 190 |
| Ex B | | | | | | |

The process for preparing EX 3 and EX 4 illustrate processes of the present invention. Polymers similar to those used in EX3 and EX4 have been shown above to have lower diffusion coefficients (lower diffusivity) with respect to fluorinated blowing agents than polystyrene and this process illustrates how to prepare polymer foam from those polymers in a continuous extrusion process that is free of expansion in a mold. Notably, those polymers are expected to have lower diffusion coefficients with respect to fluorinated blowing agents than SAA-1 or SAA-2 due to their higher acid numbers. Lower diffusion coefficients with increasing acid number is consistent with the trend observed in Table 3.

The data in Table 5 also illustrates that the SAA copolymer can be blown into foam in a similar process as standard PS resin and produce foam having similar density, cross sectional area, open cell content and average cell size.

1. A process for preparing polymer foam, the process comprising expanding a foamable polymer composition into a polymer foam wherein the foamable polymer composition comprises a copolymer component and a blowing agent, the process further characterized by:
a. the copolymer component consisting of one or more than one styrene-carboxylic acid copolymer;
b. more than 50 weight-percent of the total polymer weight in the foamable polymer composition being the copolymer component;
c. the acid number of the copolymer component being 20 or higher;
d. the blowing agent consisting of at least one fluorinated blowing agent and, optionally, one or more than one additional blowing agent selected from a group consisting of carbon dioxide, water, aliphatic and cyclic hydrocarbons having from one to nine carbons, aliphatic alcohols having from one to five carbons, acetone, 2-butanone, acetaldehyde, dimethyl ether, diethyl ether, methyl ethyl ether, methyl formate, methyl acetate, and ethyl acetate; wherein less than 70 weight-percent of the total fluorinated blowing agent is 1,1,2,2-tetrafluoroethane;
e. the blowing agent comprising less than five weight-percent carbon dioxide based on total blowing agent weight and less than 30 mole-percent hydrocarbons having from three to five carbons based on total moles of blowing agent; and
f. the foamable polymer composition expanding into a polymer foam having an average cell size of less than 0.5 millimeters as determined by ASTM D3576 and wherein the copolymer composition forms a continuous phase in the resulting polymer foam.

2. The process of claim 1, further characterized by the blowing agent comprising a fluorinated blowing agent selected from HFC-152a, HFC-134a and HFO-1234ze.

3. The process of claim 1, further characterized by the copolymer being at least 90 weight-percent of the total weight of polymers in the foamable polymer composition and resulting polymer foam.

4. The process of claim 1, further characterized by the foamable polymer composition expanding into a polymeric foam having an open cell content of less than 20 percent as measured according to ASTM D6226.

5. The process of claim 1, further characterized by the carboxylic acid being selected from a group consisting of acrylic acid and methacrylic acid.

6. The process of claim 1, further characterized by the acid number of the copolymer component being 250 or less.

7. The process of claim 1, further characterized by the foamable polymer composition and resulting foam being free of propylene carbonate, ethylene carbonate and butylene carbonate.

8. The process of claim 1, further characterized by the process being a continuous extrusion foam process.

9. The process of claim 1, further characterized by the foamable polymer composition being free of styrenic polymers other than the copolymer component.
